(19) United States
(12) Patent Application Publication
(10) Pub. No.: US 2025/0227812 A1
(43) Pub. Date: Jul. 10, 2025

(54) COMMUNICATION METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/092,902

(22) Filed: Mar. 27, 2025

Related U.S. Application Data
(63) Continuation of application No. PCT/JP2023/035273, filed on Sep. 27, 2023.
(60) Provisional application No. 63/411,243, filed on Sep. 29, 2022.

(51) Int. Cl. H04W 76/40; H04W 4/06

(52) U.S. Cl. CPC H04W 76/40; H04W 4/06

(57) ABSTRACT

A communication method used in a mobile communication system providing a multicast/broadcast service (MBS) includes the steps of communicating, by a user equipment to which a plurality of serving cells are configured, with a network by using the plurality of serving cells; and transmitting, by the user equipment to the network, request information where the user equipment requests release or deactivation of any of the plurality of serving cells, in order to perform MBS reception of a different cell different from the plurality of serving cells.

### RELATED APPLICATIONS

The present application is a continuation based on PCT Application No. PCT/JP2023/035273, filed on Sep. 27, 2023, which claims the benefit of U.S. Provisional Patent Application No. 63/411,243 filed on Sep. 29, 2022. The content of which is incorporated by reference herein in their entirety.

### TECHNICAL FIELD

The present disclosure relates to a communication method used in a mobile communication system.

### BACKGROUND

In the 3rd Generation Partnership Project (3GPP), a technical specification of New Radio (NR) that is radio access technology of the fifth generation (5G) is defined. NR has characteristics such as high speed, large capacity, high reliability, and low latency, in comparison to Long Term Evolution (LTE) that is radio access technology of the fourth generation (4G). In 3GPP, a technical specification of a multicast/broadcast service (MBS) of 5G/NR is defined (for example, see Non-Patent Document 1).

### CITATION LIST

### Non-Patent Literature

Non-Patent Document 1: 3GPP technical specification: TS 38.300 V17.1.0

### SUMMARY

A communication method according to a first aspect is a communication method used in a mobile communication system providing a multicast/broadcast service (MBS) and includes the steps of communicating, by a user equipment to which a plurality of serving cells are configured, with a network by using the plurality of serving cells; and transmitting, by the user equipment to the network, request information where the user equipment requests release or deactivation of any of the plurality of serving cells, in order to perform MBS reception of a different cell different from the plurality of serving cells.

A communication method according to a second aspect is a communication method used in a mobile communication system providing a multicast/broadcast service (MBS) and includes the steps of communicating, by a user equipment to which one or more serving cells are configured, with a network by using the one or more serving cells; having, by the user equipment, interest in MBS reception in a different cell different from the one or more serving cells; and determining, by the user equipment, whether a transmission condition where the user equipment transmits request information to the network is satisfied, the request information where the user equipment performing MBS reception in the different cell. The request information is information requesting configuration of an MBS gap or information requesting release or deactivation of a serving cell. The determining includes determining whether a condition that the network does not provide a system information block including information of a frequency targeted for the MBS reception is satisfied.

### BRIEF DESCRIPTION OF THE DRAWINGS

FIG. 1 is a diagram illustrating a configuration of a mobile communication system

according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a wireless interface of a user plane handling data.

FIG. 5 is a diagram illustrating a configuration of a protocol stack of a wireless interface of a control plane handling signaling (control signal).

FIG. 6 is a diagram illustrating an MBS Interest Indication message.

FIG. 7 is a diagram illustrating start processing of the MBS interest indication procedure.

FIG. 8 is a diagram illustrating carrier aggregation (CA).

FIG. 9 is a diagram illustrating dual connectivity (DC).

FIG. 10 is a diagram illustrating an example of an operation of the mobile communication system according to an embodiment.

FIG. 11 is a diagram illustrating an operation example of the mobile communication system according to an embodiment.

FIG. 12 is a diagram illustrating another operation example of the mobile communication system according to an embodiment.

FIG. 13 is a diagram illustrating an operation example of UE according to an embodiment.

FIG. 14 is a diagram illustrating an operation example of the mobile communication system according to an embodiment.

FIG. 15 is a diagram illustrating an operation example of the UE according to an embodiment.

FIG. 16 is a diagram illustrating an operation example of a mobile communication system according to a variation.

### DESCRIPTION OF EMBODIMENTS

A mobile communication system according to an embodiment will be described with reference to the drawings. In the description of the drawings, the same or similar parts are denoted by the same or similar reference signs.

### (1) Configuration of Mobile Communication System

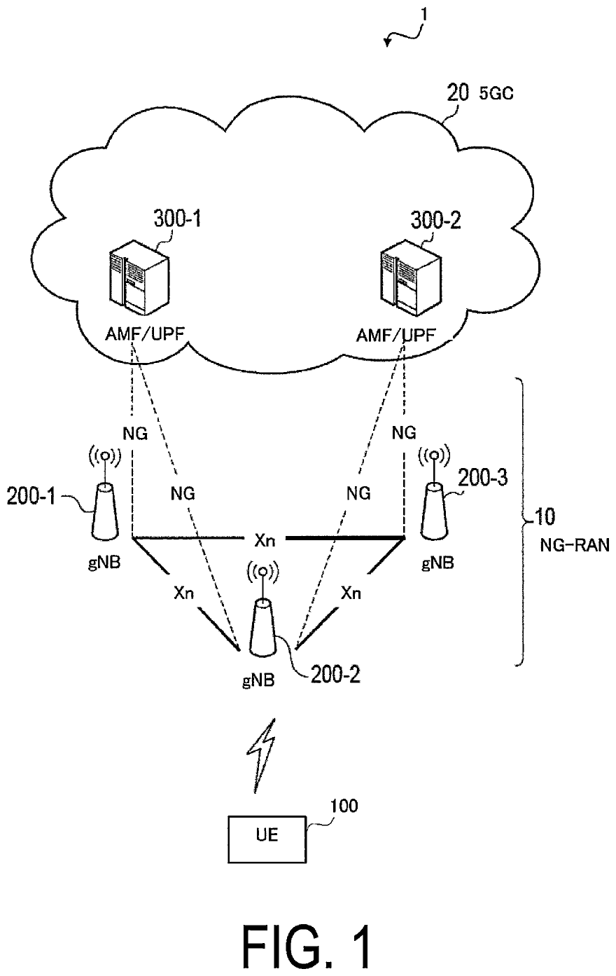

FIG. 1 is a diagram illustrating a configuration of a mobile communication system according to an embodiment. The mobile communication system 1 complies with the 5th Generation System (5GS) of the 3GPP standard. The description below takes the 5GS as an example, but Long Term Evolution (LTE) system may be at least partially applied to the mobile communication system. Alternatively, a sixth generation (6G) system may be at least partially applied to the mobile communication system.

The mobile communication system 1 includes a User Equipment (UE) 100, a 5G radio access network (NG-RAN: Next Generation Radio Access Network) 10, and a 5G Core Network (5GC) 20. Hereinafter, the NG-RAN 10 may be simply referred to as a RAN 10. Further, the 5GC 20 may be simply referred to as a core network (CN) 20.

The UE 100 is a mobile wireless communication device. The UE 100 may be any device as long as the UE 100 is used by a user. The UE 100 is, for example, a mobile phone terminal (including a smartphone) and/or a tablet terminal, a notebook PC, a communication module (including a communication card or a chipset), a sensor or a device provided on the sensor, a vehicle or a device provided on the vehicle (Vehicle UE), or a flying object or a device (Aerial UE) provided on the flying object.

The NG-RAN 10 includes a base station (referred to as “gNB” in a 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

The gNB can also be connected to an Evolved Packet Core (EPC) that is to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

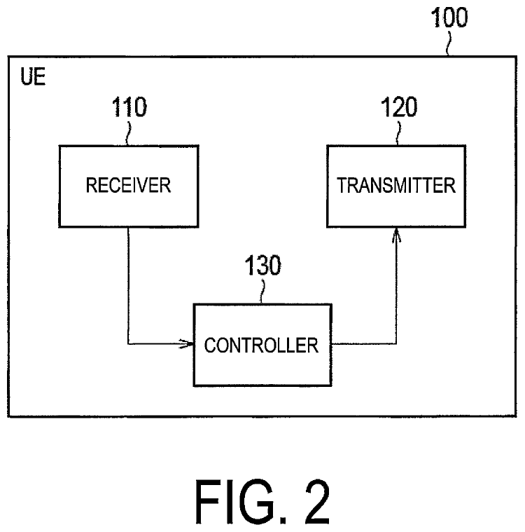

FIG. 2 is a diagram illustrating a configuration of the UE 100 (user equipment) according to an embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

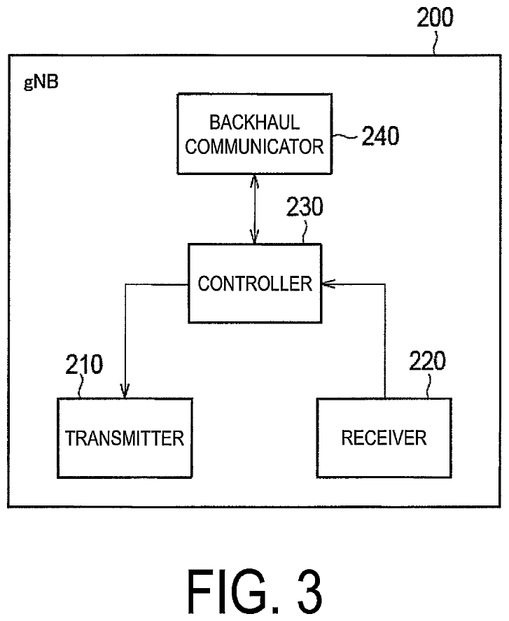

FIG. 3 is a diagram illustrating a configuration of the gNB 200 (base station) according to an embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface which is an inter-base station interface. The backhaul communicator 240 is connected to the AMF/UPF 300 via a NG interface between a base station and the core network. The gNB 200 may include a Central Unit (CU) and a Distributed Unit (DU) (that is, functions are divided), and both the units may be connected via an F1 interface that is a fronthaul interface.

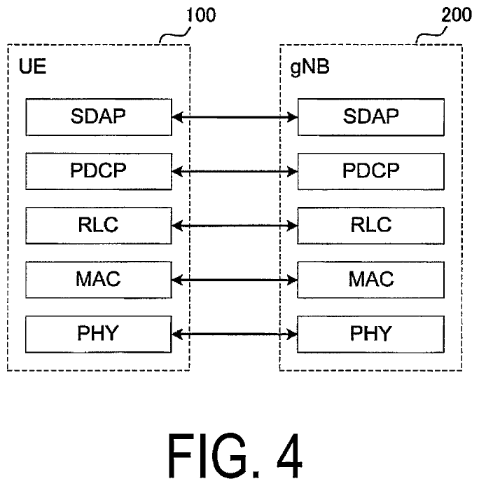

FIG. 4 is a diagram illustrating a configuration of a protocol stack of a wireless interface of a user plane that handles data.

A wireless interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

A PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. The PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

An SDAP layer performs mapping between an IP flow as the unit of Quality of Service (QoS) control performed by a core network and a radio bearer as the unit of QoS control performed by an Access Stratum (AS). When the RAN is connected to the EPC, SDAP need not be provided.

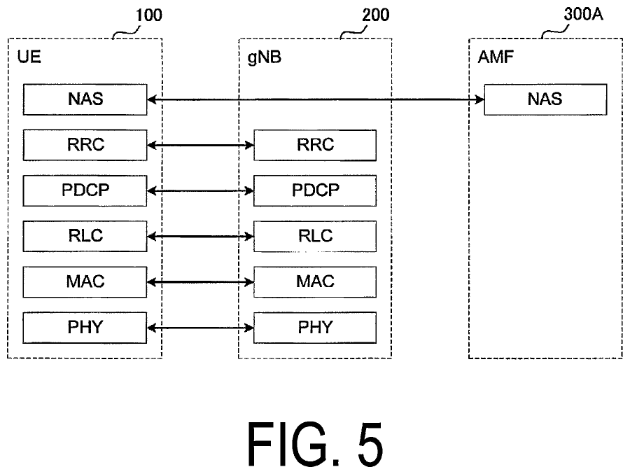

FIG. 5 is a diagram illustrating a configuration of a protocol stack of a wireless interface of a control plane that handles signaling (a control signal).

The protocol stack of the wireless interface of the control plane includes a Radio Resource Control (RRC) layer and a Non-Access Stratum (NAS) layer instead of SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When there is a connection (RRC connection) between the RRC of the UE 100 and the RRC of the gNB 200, the UE 100 is in an RRC connected state. When there is no connection (RRC connection) between the RRC of the UE 100 and the RRC of the gNB 200, the UE 100 is in an RRC idle state. When the connection between the RRC of the UE 100 and the RRC of the gNB 200 is suspended, the UE 100 is in an RRC inactive state.

The NAS layer located higher than the RRC layer performs session management, mobility management, and the like. NAS signaling is transferred between the NAS layer of the UE 100 and the NAS layer of an AMF 300A. The UE 100 includes an application layer other than the protocol of the wireless interface. A layer lower than the NAS layer is referred to as an AS layer.

### (2) Overview of MBS

The mobile communication system 1 can perform delivery with high resource efficiency through multicast/broadcast service (MBS).

In the case of a broadcast communication service (also referred to as “MBS broadcast”), the same service and the same specific content data are provided simultaneously to all UEs 100 within a geographic area. That is, all the UEs 100 in the broadcast service area are permitted to receive data. The broadcast communication service is delivered to the UE 100 using a broadcast session, which is a type of MBS session. The UE 100 can receive the broadcast communication service in any of the RRC idle state, the RRC inactive state, and the RRC connected state.

In the case of a multicast communication service (also referred to as “MBS multicast”), the same service and the same specific content data are simultaneously provided to a specific set of UEs. That is, not all the UEs 100 in the multicast service area are permitted to receive the data. The multicast communication service is delivered to the UE 100 using a multicast session, which is a type of MBS session. The UE 100 can receive multicast communication services in the RRC connected state using a mechanism such as Point-to-Point (PTP) and/or Point-to-Multipoint (PTM) delivery. The UE 100 may receive the multicast communication service in an RRC inactive (or RRC idle) state.

Hereinafter, the MBS broadcast will mainly be described. However, the embodiments are not limited to the MBS broadcast and are applicable to MBS multicast.

The UE 100 in the RRC idle state, the RRC inactive state, or the RRC connected state receives an MBS configuration (for example, parameters required for MTCH reception) for a broadcast session through a multicast control channel (MCCH). Parameters (MCCH configuration) required for reception of the MCCH are provided through system information. Specifically, a system information block type 20 (SIB20) includes the MCCH configuration. An SIB type 21 (SIB21) includes information on service continuity of MBS broadcast reception. The MCCH provides a list of all broadcast services including ongoing sessions transmitted on a multicast traffic channel (MTCH), and related information of the broadcast session includes an MBS session identifier (for example, Temporary Mobile Group Identity (TMGI)), related G-RNTI scheduling information, and information on neighboring cells providing a specific service on the MTCH.

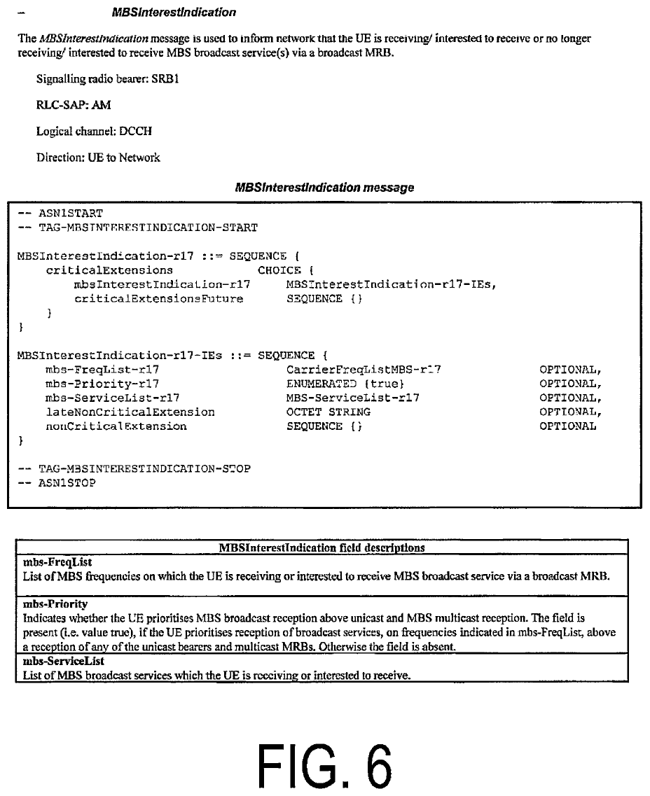

FIG. 6 is a diagram illustrating an MBS Interest Indication message defined in 3GPP Technical Specifications of RRC: TS38. 331. The MBS interest indication message (hereinafter also simply referred to as “MBS interest indication”) is the RRC message transmitted from the UE 100 to the network (gNB 200).

The MBS interest indication message (hereinafter also referred to simply as “MBS Interest Indication (MII)”) is used to indicate to the network via the broadcast MRB that the UE 100 is receiving or is interested in receiving the MBS broadcast service or is no longer receiving or is not interested in receiving the MBS broadcast service.

In order to secure service continuity of MBS broadcast, the UE 100 in the RRC connected state can transmit, to the gNB 200 providing SIB21, an MBS interest indication message that is the RRC message including the following information:
mbs-FreqList (list of MBS frequencies)
List of MBS frequencies that the UE is interested in receiving
mbs-Priority (MBS priority)
Priority between reception of all listed MBS frequencies and reception of unicast bearers mbs-ServiceList (MBS service list)

A list of MBS broadcast services (service IDs) that the UE 100 is interested in receiving (when SIB20 is scheduled on PCell of the UE 100).

The transmission of the MBS interest indication message may be implicitly enabled/disabled due to the presence of SIB21.

When the gNB 200 provides RRC configuration and/or downlink assignment to the UE 100, the UE 100 may enable the UE 100 to receive an MBS service in which the UE 100 is interested based on the MBS Interest Indication message.

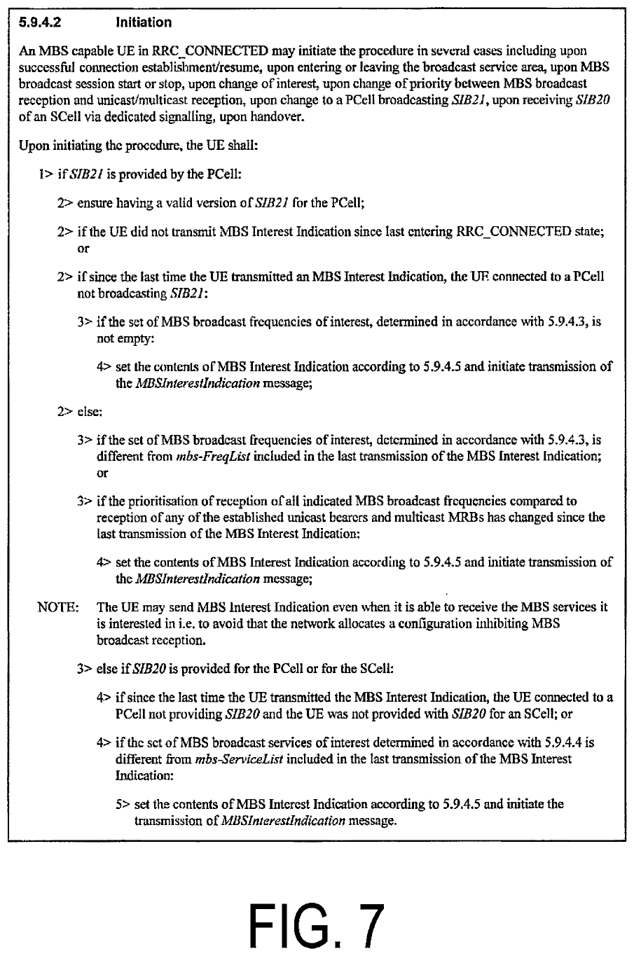

FIG. 7 is a diagram illustrating initiation processing of an MBS interest indication procedure defined in 3GPP Technical Specifications of RRC: TS38. 331.

The MBS-compatible UE 100 in the RRC connected state may initiate the procedure in several cases, such as upon successful connection establishment/resumption, upon entering/exiting a broadcast service area, upon starting or stopping an MBS broadcast session, upon a change of interest, upon a change of priorities between MBS broadcast and unicast/multicast reception, upon a change to a PCell broadcasting a SIB21, upon reception of SIB20 of an SCell via dedicated signaling, or upon handover.

### (3) Overview of Carrier Aggregation

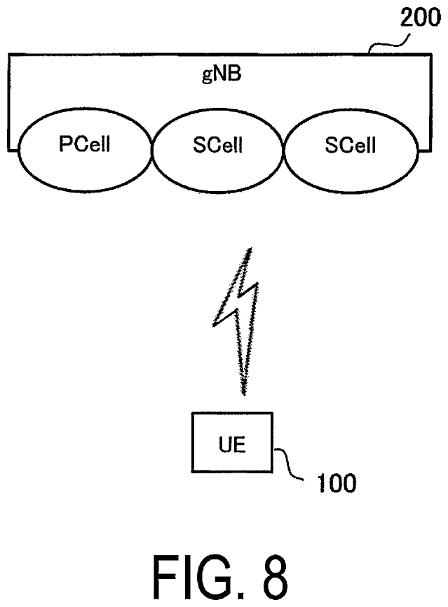

FIG. 8 is a diagram illustrating carrier aggregation (CA). In an embodiment, for the UE 100, the carrier aggregation (CA) is configured by the gNB 200. In the CA, a plurality of component carriers (CCs) corresponding to a plurality of serving cells are aggregated, so that the UE 100 can simultaneously perform reception or transmission over the plurality of CCs. The plurality of CCs may be contiguous in a frequency direction. The plurality of CCs may be non-contiguous.

When the CA is configured, there is only one RRC connection with the network (for example, gNB 200) in the UE 100. For RRC connection establishment/re-establishment/handover, one serving cell provides NAS mobility information, and for RRC connection re-establishment/handover, one serving cell provides a security input. The one serving cell is referred to as a primary cell (PCell). The primary cell is an MCG cell operating at a primary frequency at which the UE 100 performs an initial connection establishment procedure or initiates a connection re-establishment procedure. When the UE 100 receives an RRC setup message from a cell in the initial connection establishment procedure, the UE 100 regards the cell as a primary cell. A set of serving cells can be formed by configuring a secondary cell (SCell) for the UE 100 together with a PCell. Accordingly, a set of serving cells configured for the UE 100 includes one PCell and one or more SCells. Reconfiguration, addition, and deletion of SCells can be performed by RRC.

A cell activation/deactivation mechanism is supported so that power consumption of the UE 100 can be curbed when the CA is configured. When SCell is deactivated, the UE 100 does not need to receive the corresponding PDCCH or PDSCH and does not need to execute the corresponding uplink and/or CQI measurement. On the other hand, when SCell is active, the UE 100 may receive the PDSCH and PDCCH and perform CQI measurement.

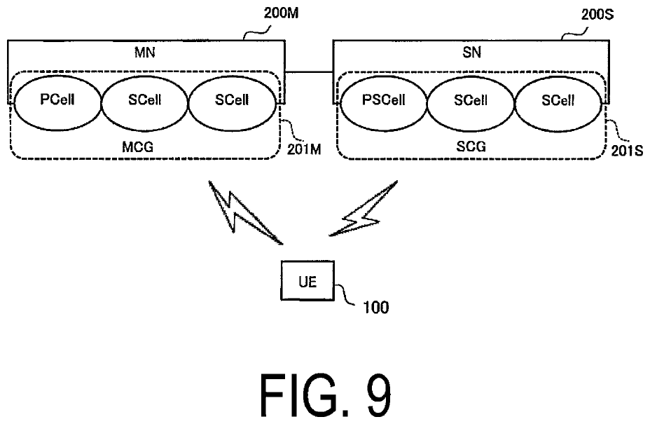

FIG. 9 is a diagram illustrating dual connectivity (DC). According to DC, the UE 100 performs communication with a master cell group (MCG) 201M managed by a master node (MN) 200M and a secondary cell group (SCG) 201S managed by a secondary node (SN) 200S. The MN 200M and SN 200S are connected to each other via a network interface (in particular, an inter-base station interface). The network interface may be an Xn interface or an X2 interface. The MN 200M may be referred to as a master base station, and SN 200S may be referred to as a secondary base station. Both the MN 200M and SN 200S may be the gNB 200.

For example, the MN 200M transmits a predetermined message (for example, SN Addition Request message) to SN 200S, and the MN 200M transmits an RRC Reconfiguration message to the UE 100 so that DC is started. In the DC, radio resources are allocated to the UE 100 in the RRC connected state by the schedulers of the MN 200M and the SN 200S and wireless communication is performed using the radio resources of the MN 200M and the radio resources of SN 200S.

The MN 200M may have control plane connection with the core network. The MN 200M provides main radio resources for the UE 100. The MN 200M manages an MCG 201M. The MCG 201M is a group of serving cells associated with the MN 200M. The MCG 201M includes a primary cell (PCell) and optionally includes one or more secondary cells (SCells). On the other hand, SN 200S may not have control plane connection with the core network. The SN 200S provides additional radio resources to the UE 100. The SN 200S manages a SCG 201S. The SCG 201S includes a primary-secondary cell (PSCell) and optionally includes one or more SCells. The PCell of the MCG 201M and the PSCell of SCG 201S are called special cells (SPCells).

In an embodiment, the UE 100 can receive MBS broadcast date and MCCH from the PCell or one SCell at a certain timing. UE-dedicated RRC signaling may be used to provide SIB20 of SCell.

### (4) Operation of Mobile Communication System

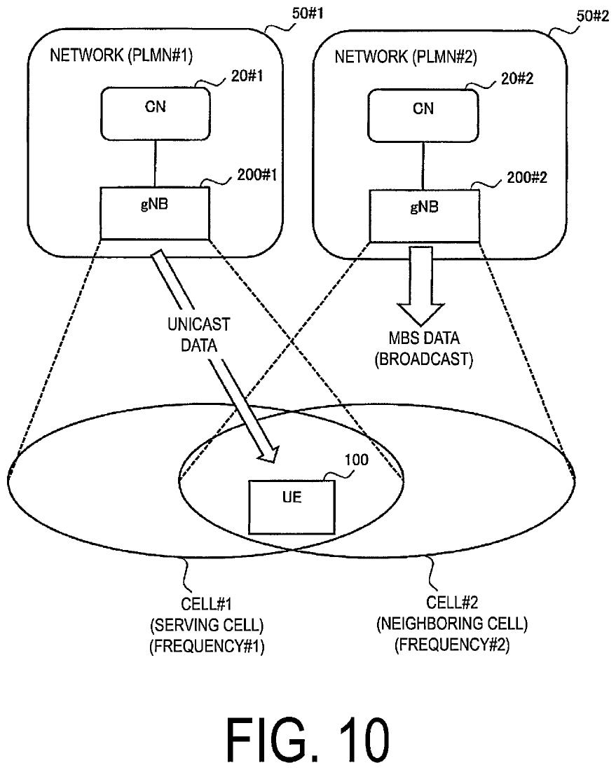

FIG. 10 is a diagram illustrating an example of an operation of the mobile communication system 1 according to an embodiment. In FIG. 10, a number denoted by “#” may mean an identifier or an index.

The UE 100 present in an overlapping area of cell #1 and cell #2 performs communication with cell #1. That is, cell #1 is a serving cell of the UE 100, and cell #2 is a neighboring cell of the serving cell. The UE 100 is in the RRC connected state, the RRC idle state, or the RRC inactive state in cell #1.

The cell #1 is operated in frequency (carrier frequency) #1, and cell #2 is operated in frequency (carrier frequency) #2. Such a relationship of frequencies is referred to as an inter-frequency. The cell #1 is managed by gNB 200 #1, and cell #2 is managed by gNB 200 #2. The cell #1 (gNB 200 #1) and cell #2 (gNB 200 #2) belong to different operators. Specifically, cell #1 (gNB 200 #1) belongs to a Public Land Mobile Network (PLMN) #1, and cell #2 (gNB 200 #2) belongs to a PLMN #2. Such a relationship of PLMNs is referred to as an inter-PLMN.

gNB 200 #1 and CN 20 #1 are included in a network 50 #1 of PLMN #1 (first PLMN). The gNB 200 #2 and the CN 20 #2 are included in the network 50 #2 of the PLMN #2 (second PLMN). In general, one operator is assigned one PLMN identifier. Each cell broadcasts an identifier of the PLMN to which the cell belongs.

The UE 100 in the RRC connected state in cell #1 performs data communication with cell #1 (gNB 200 #1). Specifically, the UE 100 is assigned a C-RNTI from the gNB 200 #1 as an identifier of RRC connection. The gNB 200 #1 assigns radio resources to the UE 100 via scheduling for the UE 100.

The UE 100 in the RRC idle state or the RRC inactive state in cell #1 performs paging monitoring from cell #1 (gNB 200 #1). Specifically, the UE 100 monitors paging transmitted from cell #1 (gNB 200 #1) at a paging reception timing (paging occasion) determined depending on a parameter, such as an identifier of the UE 100.

In the embodiment, cell #2 (gNB 200 #2) transmits MBS data belonging to an MBS session (for example, a broadcast session) in PTM. Specifically, cell #2 (gNB 200 #2) performs the MBS transmission through the MBS broadcast. Cell #2 (gNB 200 #2) may provide the MBS session in a Receive-Only Mode (ROM) and/or Free-To-Air (FTA). The ROM is a mode allowing the UE 100 to perform MBS reception even if the UE 100 does not have a Subscriber Identity Module (SIM) and/or does not have a service contract with an operator (PLMNS). For example, the UE 100 may be an apparatus (for example, a television receiver) that has a downlink reception function but does not have an uplink transmission function. The FTA is an application (service) for enabling free broadcast contents broadcasting. The FTA may be one aspect of the ROM. The MBS session provided in FTA may be provided to be available to all users who are not mobile subscribers. When ROM and FTA are not particularly distinguished, ROM and FTA are hereinafter referred to as ROM/FTA.

For example, the UE 100 belongs to PLMN #1. The UE 100 may have a SIM of PLMN #1 and/or a service contract with PLMN #1. In the description of the embodiment, it is assumed that the UE 100 is interested in receiving the MBS session provided by PLMN #2, that is, cell #2 (gNB 200 #2). It is assumed that the MBS session in ROM/FTA provided by cell #2 (gNB 200 #2) can also be received by the UE 100 belonging to PLMN #1. Here, it may be assumed that the UE 100 belonging to PLMN #1 can receive the MBS session provided in broadcast/PTM, as well as in ROM/FTA by cell #2 (gNB 200 #2).

Here, since the number of reception devices of the UE 100 is limited, it is difficult for the UE 100 to perform the MBS reception from cell #2 (gNB 200 #2) while maintaining a communicated state with cell #1 (gNB 200 #1). Specifically, it is difficult for the UE 100 to perform the MBS reception from cell #2 (frequency #2) that is an inter-frequency while maintaining cell #1 (frequency #1) as the serving cell (serving frequency) of the UE 100. For example, the UE 100 including only one reception device cannot perform the MBS reception from cell #2 (frequency #2) while performing reception from cell #1 (frequency #1). Even when the UE 100 includes a plurality of reception devices, the UE 100 cannot perform the MBS reception from cell #2 (frequency #2) in a scenario (for example, carrier aggregation) in which the plurality of reception devices are all in use for communication with network 50 #1.

Here, when gNB 200 #1 (network 50 #1) ascertains an MBS interest of the UE 100 and an MBS transmission configuration (particularly, an MBS timing) of gNB 200 #2, gNB 200 #1 can perform communication, for example, data communication or paging transmission, with the UE 100 so that the timing is avoided. Thus, the UE 100 can perform the MBS reception from cell #2 (gNB 200 #2) at the timing. However, in a scenario of the inter PLMN, since gNB 200 #1 and gNB 200 #2 belong to different PLMNs, it is difficult to share MBS transmission configurations through network coordination.

Thus, the UE 100 according to the embodiment transmits, to cell #1 (gNB 200 #1), an MBS gap request including information on the MBS gap requested to be set by the UE 100 (that is, information on an MBS reception timing at which the UE 100 performs the MBS reception from cell #2). The MBS gap is a period during which communication between the UE 100 and cell #1 is suspended in order for the UE 100 to perform the MBS reception from cell #2. The MBS gap request may be assistance information for cell #1 (gNB 200 #1) to configure the MBS gap in the UE 100.

The MBS gap request may be included in the RRC message transmitted from the UE 100 to cell #1 (gNB 200 #1). The RRC message may be a UE Assistance Information message. The RRC message may be an MBS Interest Indication message. Alternatively, the MBS gap request may be included in a NAS message transmitted from the UE 100 to the CN 20 #1 (AMF 300A) via cell #1 (gNB 200 #1). The NAS message may be a CONFIGURATION UPDATE COMPLETE message, a REGISTRATIN REQUEST message, or a SERVICE REQUEST message.

A network device included in network 50 #1, for example, gNB 200 #1 or CN 20 #1 (AMF 300A) receives the message from the UE 100 via cell #1. Thus, the network device can perform communication, for example, data communication or paging transmission, with the UE 100 so that the MBS reception timing at which the UE 100 performs the MBS reception from cell #2 is avoided.

### (4.1) Basic Operation Example for Gap Request

In the present operation example, the gNB 200 #1 that has received the MBS gap request from the UE 100 transmits the MBS gap configuration indicating the configuration of the MBS gap to the UE 100 via cell #1. The UE 100 receives the MBS gap configuration from cell #1. The UE 100 suspends data communication with cell #1 and performs the MBS reception from cell #2 in the MBS gap, based on the MBS gap configuration from gNB 200 #1. Thus, the UE 100 is enabled to perform the MBS reception from cell #2 while maintaining the RRC connected state with cell #1 (gNB 200 #1).

In the present operation example, the UE 100 generates requested gap information indicating the configuration of the MBS gap requested by the UE 100, based on a configuration of the MCCH of cell #2 and/or a configuration of the MTCH of cell #2. The UE 100 transmits a message including the requested gap information to cell #1 (gNB 200 #1). Cell #1 (gNB 200 #1) receives the message including the requested gap information, and transmits the MBS gap configuration based on the requested gap information to the UE 100. Thus, the MBS gap can be appropriately configured for the UE 100.

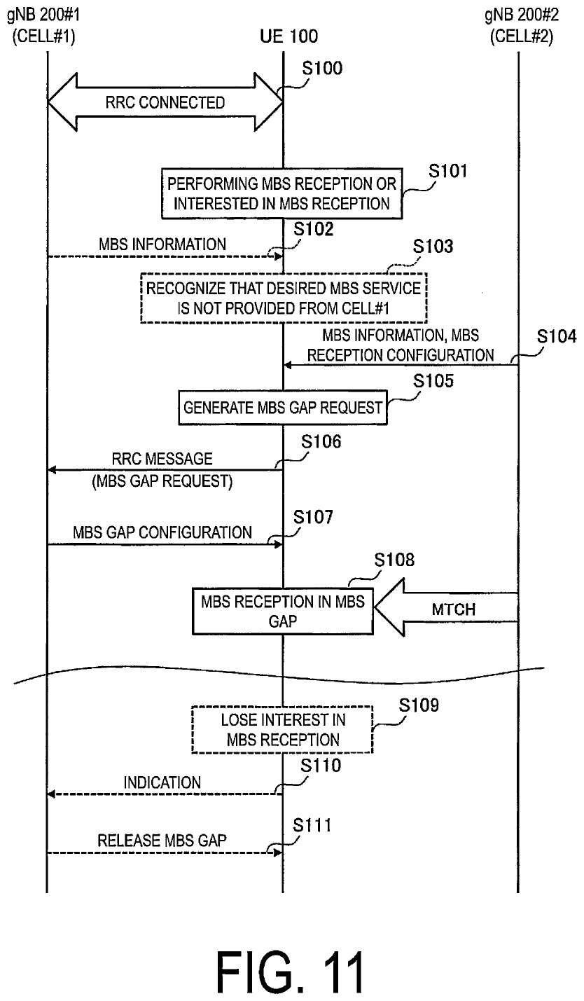

FIG. 11 is a diagram illustrating the present operation example. In the following description of the embodiment, cell #1 (gNB 200 #1) may be read as the network 50 #1 (PLMN #1), and cell #2 (gNB 200 #2) may be read as the network 50 #2 (PLMN #2).

In step S100, the UE 100 is in the RRC connected state in cell #1.

In step S101, the UE 100 is performing MBS reception or is interested in the MBS reception. For example, the UE 100 is performing reception of the MBS session (for example, the broadcast session) provided in ROM/FTA or is interested in the reception. The UE 100 may acquire higher layer information indicating a correspondence relationship between the MBS session (MBS session identifier) and a frequency (frequency identifier) in advance. The higher layer information may further include information indicating a start time of the MBS session and/or information indicating an MBS service area in which the MBS session is provided. The UE 100 may ascertain a desired MBS frequency for providing the MBS session (desired MBS session), based on the higher layer information. Such higher layer information may be provided as User Service Description (USD) or may be provided by a NAS message (for example, a REGISITRATION ACCEPT message, a CONFIGURATION UPDATE COMMAND message, or a PDU SESSION ESTABLISHMENT ACCEPT message).

In step S102, the UE 100 may receive, from cell #1 (gNB 200 #1), the MBS information indicating the correspondence relationship between the MBS session provided by the network 50 #1 and the frequency and/or the MBS session provided by cell #1 in ROM/FTA. Such MBS information may be information that is broadcast in SIB or the MCCH of cell #1. For example, the MBS information indicating the correspondence relationship between the MBS session provided by the network 50 #1 and the frequency may include a plurality of sets of the MBS session identifier and the frequency identifier. The UE 100 can ascertain which MBS session is provided in which frequency based on such MBS information. The MBS information indicating the MBS session provided by cell #1 in ROM/FTA may include an MBS session identifier list of the MBS sessions provided by cell #1 in ROM/FTA. The UE 100 can ascertain which MBS session is provided by cell #1 in ROM/FTA based on such MBS information.

In step S103, the UE 100 recognizes that a desired MBS session is not provided from the network 50 #1 based on the MBS information received in step S102. For example, the UE 100 may recognize that the desired MBS session is not provided from the network 50 #1 when a desired MBS session and/or a desired MBS frequency is not indicated by the MBS information, based on the MBS information indicating the correspondence relationship between the MBS session provided by the network 50 #1 and the frequency. When the desired MBS frequency for providing the desired MBS session to which ROM/FTA is applied is not indicated by the MBS information, the UE 100 may recognize that the desired MBS session and/or the desired MBS frequency may be provided from another network, that is, the network 50 #2.

In step S104, the UE 100 may receive, from cell #2 (gNB 200 #2), a correspondence relationship between the MBS session provided by network 50 #2 and the frequency and/or the MBS information indicating the MBS session provided by cell #2 in ROM/FTA. Such MBS information may be information that is broadcast in SIB or the MCCH of cell #2. The UE 100 may confirm that the desired MBS session and/or the desired MBS frequency is provided from cell #2 based on the MBS information.

In step S104, the UE 100 receives the MBS reception configuration in cell #2 from cell #2. Such MBS reception configuration includes the MCCH configuration information broadcast in SIB (SIB20) of cell #2 and/or the MTCH configuration information broadcast in the MCCH of cell #2. For example, after receiving the MCCH configuration information using the SIB20 transmitted on the BCCH from cell #2, the UE 100 receives the MCCH from the gNB 200 based on the MCCH configuration information to receive the MTCH configuration information. The MCCH configuration information includes scheduling information of the MCCH, that is, information indicating an MCCH reception timing (MCCH reception occasion). The MTCH configuration information includes scheduling information of the MTCH, that is, information indicating an MTCH reception timing (MTCH reception occasion). Such an

MCCH reception timing (MCCH reception occasion) and/or an MTCH reception timing (MTCH reception occasion) corresponds to the MBS reception timing for the UE 100 to perform the MBS reception from cell #2. Specifically, the MTCH reception timing constituting the MBS reception timing may be an MTCH reception timing associated with the desired MBS session among MTCH reception timings indicated for each MBS session through the MCCH.

In step S105, the UE 100 determines a gap pattern configuration of the MBS gap for suspending data communication with cell #1 based on the MBS reception timing ascertained in step S104, and generates requested gap information indicating the determined gap pattern configuration. The gap pattern refers to a pattern of periodically repeated MBS gap. The requested gap information includes information indicating a start timing of the gap pattern (a system frame number and/or a subframe number) and information indicating the gap pattern, for example, a bitmap for each subframe or a period (cycle length) of the MBS gap. The requested gap information may include information indicating duration of each MBS gap. The UE 100 determines a requested gap pattern according to a timing (a system frame number or the like) of cell #1. Here, when the UE 100 determines the requested gap pattern, the UE 100 may add, to the requested gap pattern, a time (margin) necessary to change the frequency of the reception device of the UE 100 and/or a measurement time for establishing synchronization with cell #2.

In step S106, the UE 100 transmits the RRC message including the requested gap information generated in step S105 to cell #1 (gNB 200 #1). The UE 100 may further include, in the RRC message, a desired MBS session identifier (for example, a TMGI) and/or a desired MBS frequency identifier associated with the requested gap information.

In step S107, cell #1 (gNB 200 #1) generates the MBS gap configuration indicating the configuration of the MBS gap (gap pattern), based on the requested gap information in the RRC message received from the UE 100 in step S106, and transmits the MBS gap configuration to the UE 100. For example, cell #1 (gNB 200 #1) transmits an RRC Reconfiguration message including the MBS gap configuration to the UE 100. A type of information included in the MBS gap configuration may be the same as or similar to the type of information included in the requested gap information. Cell #1 (gNB 200 #1) may further include, in the RRC reconfiguration message, a cell identifier and/or a cell group identifier associated with the MBS gap configuration. Cell #1 (gNB 200 #1) may include, in the RRC reconfiguration message, a plurality of sets of the MBS gap configuration and the cell identifier and/or the cell group identifier.

In step S108, the UE 100 suspends data communication with cell #1 (gNB 200 #1) and performs MBS reception of the desired MBS session from cell #2 (gNB 200 #2) in the MBS gap indicated by the MBS gap configuration received from cell #1 (gNB 200 #1) in step S107. Specifically, the UE 100 changes (tunes) a reception frequency of the reception device from frequency #1 to frequency #2, and then performs MBS reception, that is, MTCH reception (and MCCH reception), from cell #2 (gNB 200 #2). Cell #1 (gNB 200 #1) does not assign radio resources to the UE 100 in the configured MBS reception gap.

Here, when the UE 100 uses a plurality of serving cells (or a plurality of cell groups) for communication with network 50 #1 (that is, in the case of carrier aggregation or dual connectivity), the UE 100 may identify the serving cell (and/or the cell group) to which the MBS gap configuration is applied, based on the cell identifier and/or the cell group identifier in the RRC reconfiguration message, and perform the MBS reception from cell #2 (gNB 200 #2) using the reception device assigned to the identified serving cell (and/or cell group). The reception device assigned for a serving cell (and/or a cell group) other than the identified serving cell (and/or cell group) may remain on the frequency/serving cell as it is and continue reception from the serving cell.

When the UE 100 loses interest in the MBS reception from cell #2 (gNB 200 #2) (step S109), the UE 100 may perform indication to cell #1 (gNB 200 #1) (step S110). The UE 100 may transmit the indication in the RRC message, for example, a UE Assistance Information message or an MBS Interest Indication message. The indication may be a request to release the gap. The indication may be an MBS reception gap request not including the requested gap pattern. Cell #1 (gNB 200 #1) may remove (release) the MBS reception gap configuration from the UE 100 based on the indication (step S111).

Through such an operation, for example, even when the number of reception devices of the UE 100 is limited, the UE 100 can continue the unicast communication with cell #1 (gNB 200 #1) and receive the MBS broadcast from cell #2 (gNB 200 #2) by using the MBS gap.

### (4.2) Gap Request During CA/DC

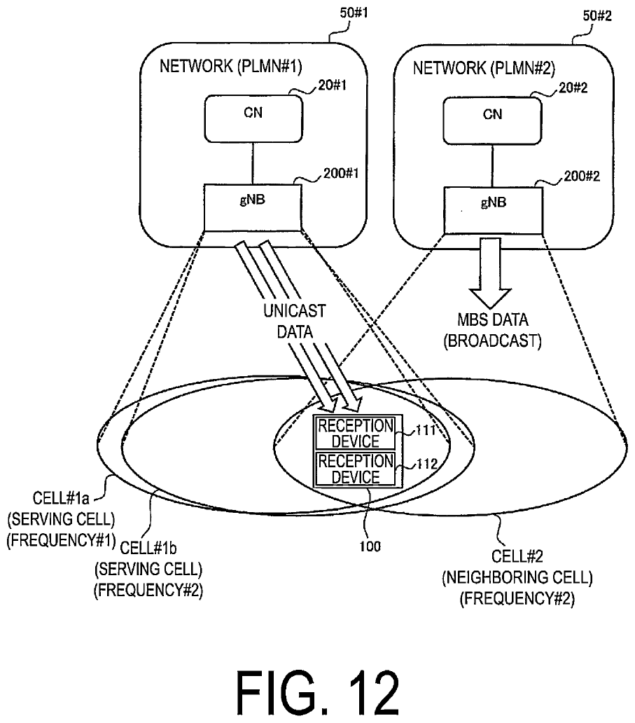

FIG. 12 is a diagram illustrating another example of the mobile communication system 1 according to an embodiment.

In the present operation example, it is assumed that a plurality of serving cells (serving cell #1a and serving cell #1b in the illustrated example) are configured for the UE 100 by CA or DC in the network 50 #1. In the illustrated example, frequencies (carrier frequencies) of the serving cell #1a and the serving cell #1b are different from each other, the serving cell #la is operated at the frequency #1, and the serving cell #1b is operated at the frequency #2.

The UE 100 communicates with the network 50 #1 using the plurality of serving cells. For example, the UE 100 includes two reception devices 111 and 112. The reception devices 111 and 112 may support different frequencies from each other. For example, the UE 100 uses the reception device 111 for unicast reception from the serving cell #1a and uses the reception device 112 for unicast reception from the serving cell #1b. One reception device may correspond to one wireless device (RF chain).

As described above, there is a problem in that the network 50 #1 (gNB 200 #1) does not know which reception device the MBS gap is to be applied when the UE 100 uses a different reception device at the time of CA or DC. Here, all the reception devices in the UE 100 do not support all frequencies, and reception devices supporting the MBS frequencies need to be used for MBS reception. However, the network 50 #1 (gNB 200 #1) is likely not to know such information.

In the present operation example, the UE 100 transmits, to the network 50 #1, an MBS gap request including the information on the MBS gap requested to be set by the UE 100 in order to perform MBS reception of a different cell #2 different from the plurality of serving cells #1a and #1b. Here, the MBS gap request further includes identification information on the target serving cell as a target of MBS gap configuration among the plurality of serving cells. Accordingly, the network 50 #1 (for example, gNB 200 #1) can appropriately determine which serving cell the MBS gap to be configured based on the identification information.

The different cell #2 belongs to a different network 50 #2 of an operator (PLMN #2) different from the operator (PLMN #1) of the network 50 #1. That is, in the present operation example, a scenario of the inter PLMN is mainly assumed. However, the present operation example is not limited to the inter PLMN scenario and is also applicable to an intra PLMN scenario.

The identification information included in the MBS gap request includes at least one of an identifier of the target serving cell, an identifier of a cell group to which the target serving cell belongs, or an identifier of a frequency of the target serving cell.

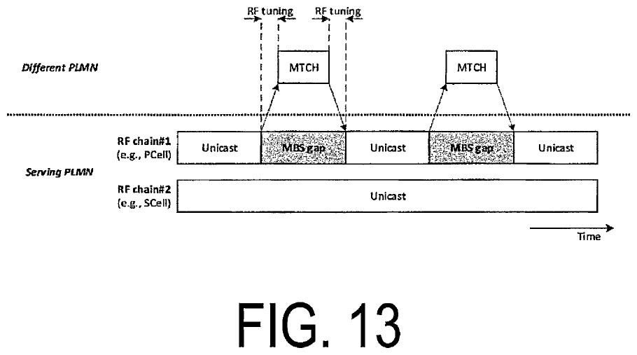

FIG. 13 is a diagram illustrating an example of an operation of the UE 100. In the illustrated example, in the serving PLMN (network 50 #1) of the UE 100, the UE 100 uses RF chain #1 for communication with the PCell and uses RF chain #2 for communication with SCell. For example, the UE 100 uses RFchain #1 (reception device #1) for unicast reception from the PCell and uses RFchain #2 (reception device #2) for unicast reception from SCell.

Periodic MBS gaps are configured in the PCell. In the MBS gap, the UE 100 suspends the unicast reception from the PCell of the serving PLMN (network 50 #1) and receives, through the RF chain #1 (reception device #1), the MBS data transmitted through the MTCH of the different PLMN (network 50 #2). Although an example in which MTCH transmission in the different PLMN (network 50 #2) is MBS broadcast will be described below, the MTCH transmission is not limited to MBS broadcast and may be MBS multicast. In each MBS gap, a tuning period for tuning the RF chain #1 (reception device #1) is provided before and after each MTCH period.

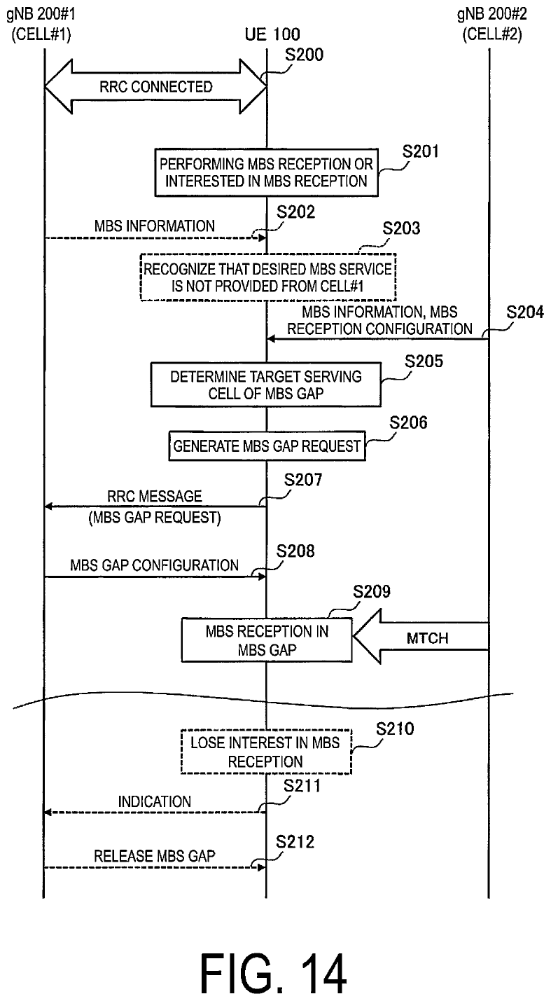

FIG. 14 is a diagram illustrating the present operation example. Here, redundant description of an operation that overlaps with the above-described operation example will be omitted.

Steps S200 to S204 are the same as or similar to the above-described operation example. However, in the present operation example, the UE 100 is interested in receiving an MBS broadcast provided by the different PLMN (PLMN #2) (step S201).

In step S205, the UE 100 determines a target serving cell of the MBS gap. For example, the UE 100 identifies an RF chain/reception device that supports the frequencies of the MBS broadcast that the UE 100 is interested in and identifies the serving cell with which the RF chain/reception device is communicating, as the target serving cell.

In steps S206 and S207, the UE 100 generates and transmits the RRC message including an MBS gap request. The gNB 200 #1 receives the RRC message. As described above, the RRC message may be an MBS Interest Indication message. The RRC message may be a UE Assistance Information message. The UE assistance information message is an example of the RRC message that may be autonomously transmitted by the UE 100.

The RRC message (MBS gap request) includes identification information indicating a serving cell to which the request is to be applied. The RRC message (MBS gap request) may include the gap information as described above, for example, information such as a start timing, period, pattern (bitmap), and MBS gap length of the MBS gap. Further, the identification information includes at least one of an identifier of the target serving cell (a physical cell ID or a cell index), an identifier of a cell group to which the target serving cell belongs (for example, an identifier of an MCG/SCG or an identifier of a DRX group), or an identifier of a frequency of the target serving cell (for example, an Absolute Radio-Frequency Channel Number (ARFCN) or a band combination). The RRC message (MBS gap request) may include an MBS session identifier (such as TMGI) to which the request is applied.

In step S208, gNB 200 configures an MBS gap for the UE 100 in consideration of the MBS gap request of step S207. Here, gNB 200 #1 designates a cell ID and the like to perform MBS gap configuration. gNB 200 #1 may designate the reception device in UE 100 to perform MBS gap configuration. Steps S209 to S212 are the same as or similar to the above-described operation example.

### (4.3) Transmission Condition of Gap Request

As described above, the MBS gap request includes information on the MBS gap requested (desired) by the UE 100, for example, information such as a start timing, a period, a pattern (bitmap), and an MBS gap length of the MBS gap. Such an MBS gap is determined based on the configuration of the MTCH (that is, MTCH scheduling information) of the MBS service (for example, MBS broadcast) in which the UE 100 is interested.

In the above-described operation example, when gNB 200 #1 and gNB 200 #2 belong to the same PLMN, that is, in an intra PLMN scenario, gNB 200 #1 may ascertain the MTCH scheduling information of gNB 200 #2. Under such an assumption, the gNB 200 #1 can identify the TMGI and/or frequency of the MBS service in which the UE 100 is interested, based on the MBS Interest Indication message from the UE 100 to ascertain the MTCH scheduling.

Therefore, even when there is no MBS gap request from the UE 100, the gNB 200 #1 may set the MBS gap for the UE 100 based on the MBS interest indication message, so that the transmission of the MBS gap request by the UE 100 may be a useless process. In the following description of the operation example, a condition (trigger condition) for the UE 100 to transmit the MBS gap request will be described. This operation example may be performed appropriately in combination with the operation example described above.

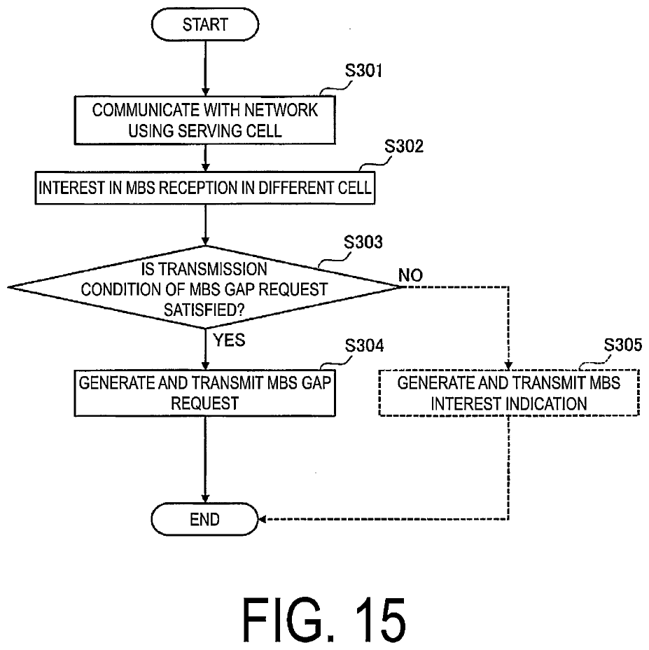

FIG. 15 is a diagram illustrating an operation example of the UE 100. In the present operation example, it is mainly assumed that the MBS gap request is transmitted in a message different from the MBS Interest Indication message.

In step S301, the UE 100 in the RRC connected state in which one or more serving cells are configured communicates with the network 50 #1 using the one or more serving cells.

In step S302, the UE 100 is interested in MBS reception in a different cell (which may be on a different frequency) different the one or more serving cells. That is, the UE 100 determines that the UE 100 wants the MBS reception in the different cell.

In step S303, the UE 100 determines whether the MBS gap request transmission condition (trigger condition) is satisfied. The conditions include at least one of
A first condition indicating that the serving cell and the different cell belong to different operators (different PLMN #1);
A second condition indicating that transmission of the MBS interest indication message to the serving cell is not permitted;
A third condition indicating that the serving cell requests or permits transmission of an MBS gap request; or
A fourth condition that gNB 200 #1 (network 50 #1) does not provide SIB including information on frequencies targeted for MBS reception (that is, frequencies for providing the MBS session/MBS service that the UE 100 is interested in receiving).

Among the first to fourth conditions, the first condition may be an essential condition, and the second to fourth conditions may be optional conditions. However, in an intra PLMN scenario, a case where gNB does not ascertain the MTCH scheduling of other gNBs is also assumed. Therefore, the first condition may not be an essential condition.

When the first condition is used, the UE 100 may determine to generate and transmit an MBS gap request in response to determining that a PLMN different from the current serving PLMN is providing an MBS session (for example, a broadcast session) that the UE 100 is interested in receiving. Here, the UE 100 identifies the MBS service ID, specifically, the TMGI, that the UE 100 is interested in receiving. The TMGI includes a PLMN identifier (plmn-Id) and a service identifier (serviceld), and is used to identify an MBS session. The service identifier uniquely identifies the MBS service (or the MBS session in another aspect) within the PLMN. Therefore, the UE 100 can identify the PLMN that provides the MBS session that the UE 100 is interested in receiving through the PLMN identifier (plmn-Id) included in the TMGI. The UE 100 determines whether or not the identified PLMN is provided by the PLMN (selected PLMN) to which the UE 100 is currently connected.

When the second condition is used, the UE 100 may determine to generate and transmit the MBS gap request in response to determining that transmission of the MBS interest indication message is not permitted by SIB21. For example, the UE 100 may determine whether the serving cell is actually broadcasting SIB21. Alternatively, the UE 100 may determine whether SIB type 1 (SIB1) indicates that a broadcast of SIB21 is scheduled.

When the third condition is used, the UE 100 may determine generation and

transmission of the MBS gap request in response to determining that the serving cell (gNB 200 #1) requests or permits transmission of the gap request rather than the MBS interest indication message. For example, the UE 100 may determine whether or not the gNB 200 #1 indicates that transmission of the MBS gap request is requested (or permitted) through SIB. Alternatively, the UE 100 may determine whether or not a UE-dedicated configuration (for example, an RRC Reconfiguration message) indicating that transmission of the MBS gap request is requested (or permitted) is received from the gNB 200 #1.

When the fourth condition is used, the UE 100 acquires the SIB from gNB 200 #1 and confirms whether information on the frequency (that is, frequency of interest) providing an MBS session (MBS service) that the UE 100 is interested in receiving is included in the SIB. When the information on the frequencies of interest is not provided in SIB by gNB 200 #1, the MBS session that UE 100 is interested in receiving is regarded as being provided by a PLMN different from the serving PLMN to which gNB 200 #1 belongs. Alternatively, even when the MBS session is provided by the same PLMN, it can be assumed that gNB 200 #1 does not have configuration information (such as a transmission period of the MCCH and/or the MTCH) at the frequency for providing the MBS session that UE 100 is interested in receiving. Therefore, the UE 100 transmits an MBS gap request to the gNB 200 #1 based on the fact that the gNB 200 #1 does not provide the information on the frequency of interest in SIB (step S304). Here, SIB used for the determination of the fourth condition is at least one of
SIB4: SIB for inter-frequency cell reselection of NR,
SIB5: SIB for Inter-RAT (LTE) cell reselection, or
SIB21: SIB for MBS service continuity. When SIB 1 indicates that these SIBs are not broadcast, the UE 100 requests the gNB 200 #1 to transmit SIBs and then acquires SIBs. The fourth condition can also be regarded as a specific example (subordinate concept) of the first condition.

When it is determined that the transmission condition (trigger condition) of the MBS gap request is satisfied (step S303: YES), the UE 100 generates an MBS gap request and transmits the MBS gap request to the serving cell (gNB 200 #1) in step S304. The UE 100 may transmit a UE assistance information message including an MBS gap request to the serving cell (gNB 200 #1). The UE 100 may determine that the transmission condition (trigger condition) of the MBS gap request is satisfied when one of the first condition to the fourth condition is satisfied. Alternatively, the UE 100 may determine that the transmission condition (trigger condition) of the MBS gap request is satisfied when two or three of the first condition to the fourth condition are satisfied.

On the other hand, when it is determined that the transmission condition (trigger condition) of the MBS gap request is not satisfied (step S303: NO), the UE 100 does not transmit the MBS gap request. The UE 100 may transmit the MBS interest indication message to the serving cell (gNB 200 #1) without transmitting the MBS gap request (step S305). In this case, the UE 100 may include a 1-bit flag (gap request flag) for requesting a configuration of an MBS gap in the MBS interest indication message. The UE 100 may include, in MBS interest indication message, a gap request flag associated with an entry of the mbs-FreqList (MBS frequency list) or an entry of the mbs-ServiceList (MBS service list).

In the present operation example, it is assumed that the MBS gap request is transmitted in a message different from the MBS interest indication message, for example, the UE assistance information message, but the MBS gap request may be transmitted as an information element (IE) of the MBS interest indication message. In this case, the determination of the second condition may be unnecessary. Alternatively, the UE 100 may be permitted to transmit the MBS interest indication message only when a gap request IE is included even when SIB21 is not broadcast.

Further, although the transmission condition of the MBS gap request has been described in the present operation example, the present operation example may be applied to transmission of an SCell release request (or an SCell deactivation request) to be described later. That is, the MBS gap request in the present operation example may be read as an SCell release request (or an SCell deactivation request).

### (4.4) Variation of Operation of Mobile Communication System

In the above-described embodiment, after the UE 100 transmits the message including the requested gap information (MBS gap request) to the gNB 200 #1, the gNB 200 #1 transmits the MBS gap configuration based on the requested gap information to the UE 100, thereby configuring the MBS gap in the UE 100.

On the other hand, in the present variation, the gNB 200 #1 releases one of a plurality of serving cells (for example, serving cells #1a and #1b) of the UE 100 instead of configuring such an MBS gap. The serving cell to be released is at least one secondary cell (SCell). Through such cell release, any of a plurality of reception devices (for example, the reception devices 111 and 112) in the UE 100 can be used for MBS reception (particularly, broadcast reception) in the neighboring cell #2 (frequency #2).

The release of SCell may be to release the configuration of SCell, that is, to de-configure the configuration of SCell. Deactivation of SCell may be used instead of the release of SCell. The deactivation is to maintain the configuration of SCell without releasing the configuration and to stop using SCell. Hereinafter, release of SCell will be mainly described, but this may be read as deactivation of SCell. Further, the “MBS gap” according to the above-described embodiments and the variations thereof may be read as “SCell release (or SCell deactivation)”.

In the present embodiment, the UE 100 that communicates with the network 50 #1 (gNB 200 #1) using a plurality of serving cells transmits, to the network 50 #1 (gNB 200 #1), request information for requesting the UE 100 to release or deactivate any serving cell in order to perform MBS reception of a different cell different from the plurality of serving cells. Specifically, the request information is information for requesting release or deactivation of an SCell among the plurality of serving cells. The request information may include an identifier of a serving cell to be released or deactivated. The request information may include an identifier of a frequency to be released or deactivated.

Accordingly, the network 50 #1 (gNB 200 #1) can appropriately release or deactivate SCell of the UE 100. As a result, the UE 100 can use the reception device used for communication with SCell, for MBS reception in the neighboring cell #2 (frequency #2). Here, since the primary cell (PCell) is maintained without being released, the UE 100 can maintain the RRC connected state with the network 50 #1 (gNB 200 #1). Therefore, the UE 100 can perform MBS reception (for example, broadcast reception) from the neighboring cell #2 (frequency #2) belonging to the different PLMN while maintaining the RRC connected state with the network 50 #1 (gNB 200 #1).

Thereafter, when the UE 100 ends the MBS reception of the neighboring cell #2 (frequency #2), the UE 100 may transmit indication information regarding the ending to the network 50 #1 (gNB 200 #1). As a result, the network 50 #1 (gNB 200 #1) can configure SCell again in the UE 100 or activate the configured SCell.

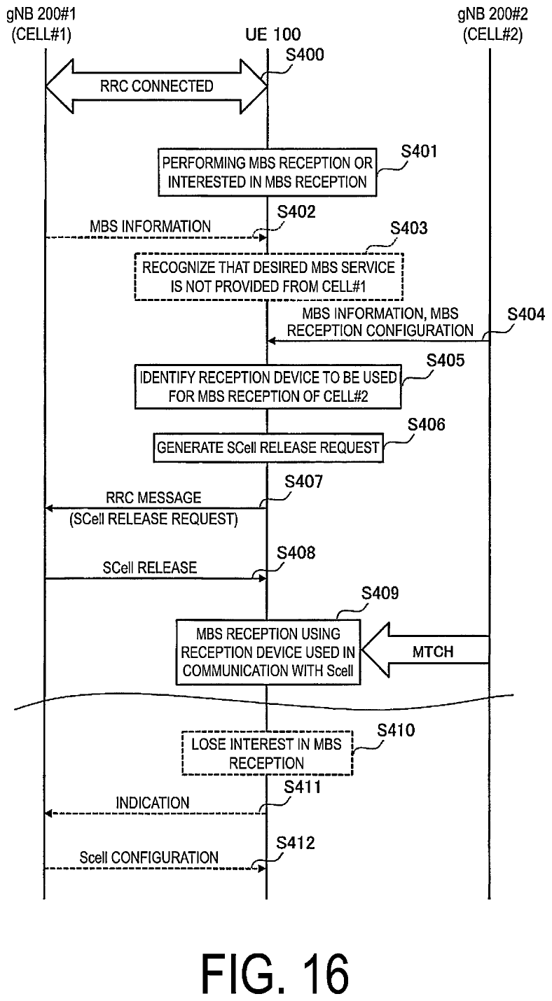

FIG. 16 is a diagram illustrating the present operation example. Here, redundant description of an operation that overlaps with the above-described operation example will be omitted.

Steps S400 to S404 are the same as or similar to the above-described operation example. However, in the present operation example, it is assumed that CA or DC is configured in the UE 100, and a plurality of serving cells are configured in the UE 100. Further, it is assumed that all of the reception devices (for example, the reception devices 111 and 112) included in the UE 100 are used for communication with the plurality of serving cells. Under this assumption, the UE 100 is interested in reception of an MBS session (MBS service) provided by cell #2 (gNB 200 #2) belonging to the different PLMN (PLMN #2) (step S401). The MBS session may be a broadcast session. The UE 100 may identify the MBS session and the frequency in which the UE 100 is interested (frequency of interest) through User Service Description (USD) information provided in a higher layer.

In step S405, the UE 100 identifies a reception device that wants release of a corresponding serving cell among a plurality of reception devices. For example, the UE 100 may compare support frequencies for each reception device with a frequency (frequency of interest) that provides MBS sessions (MBS services) that the UE 100 is interested in receiving, and identify reception devices that support the frequency of interest. Further, the UE 100 may identify a cell ID of a serving cell (PCell/SCell (including PSCell)) in which the reception device is used for communication. The UE 100 may identify the band combinations supported by the reception device.

In step S406, the UE 100 generates an SCell release request message based on a determination result of step S405. The message may be the RRC message, for example, a UE assistance information (UAI) message, an MBS interest indication (MII) message, or a newly defined RRC message.

The message may include information on the reception device identified in step S405 (for example, the cell ID). The message may include an identifier of the frequency of interest (and/or a band number to which the frequency of interest belongs). The message may include a frequency band combination desired to be released by the UE 100.

The message may include information indicating a request for performing MBS reception. The information may be a message name or an IE name (such as “MBS SCell release request”) of the message. The information may be information set in a Cause field of the message. The message may include, as accompanying information, a TMGI indicating the MBS session that the UE 100 is interested in receiving.

In step S407, the UE 100 transmits the RRC message for the SCell release request generated in step S406 to gNB 200 #1. The gNB 200 #1 receives the message.

In step S408, the gNB 200 #1 determines release of SCell based on the message

received from the UE 100 in step S407, and transmits an RRC reconfiguration message including information for releasing SCell to the UE 100. For example, the gNB 200 #1 determines to release SCell indicated by the cell ID in the message or SCell belonging to the frequency or identifier the band number in the message. The UE 100 releases the designated SCell in response to receiving the RRC reconfiguration message.

When deactivation of SCell is performed instead of release of SCell, the gNB 200 #1 transmits SCell deactivation MAC CE to the UE 100 instead of the RRC reconfiguration message. In response to receiving the MAC CE, the UE 100 deactivates the designated SCell.

In step S409, the UE 100 performs MBS reception of the desired MBS session from cell #2 (gNB 200 #2) using the reception device used for communication with SCell released (or deactivated) in step S408. For example, the UE 100 changes (tunes) a reception frequency of the reception device from frequency #1 to frequency #2, and then performs MBS reception, that is, MTCH reception (and MCCH reception), from cell #2 (gNB 200 #2).

When the UE 100 is no longer interested in the MBS reception from cell #2 (gNB 200 #2) (step S410), the indication to cell #1 (gNB 200 #1) may be performed in step S411. The UE 100 may transmit the indication in the RRC message, for example, a UE Assistance Information message or an MBS Interest Indication message. The indication may be an indication indicating that the reception device used for MBS reception is available. The indication may request configuration of SCell or activation of SCell. In step S412, cell #1 (gNB 200 #1) may perform configuration of SCell or activation of SCell with respect to the UE 100.

According to the operation according to the present variation, for example, even when the number of the reception devices of the UE 100 is limited, the UE 100 can continue the unicast communication with cell #1 (gNB 200 #1) and can receive the MBS from cell #2 (gNB 200 #2) by using the reception device of which the corresponding secondary cell has been released.

### (5) Other Embodiments

In the description of the above-described embodiment, the inter PLMN scenario has been mainly described. However, the embodiment is also applicable to the intra PLMN scenario. Further, an operation example in which a static MBS gap is requested and configured using the RRC message has been described in the above-described embodiment, but the embodiment is not limited thereto. The UE 100 may dynamically request the MBS gap using layer 1 or layer 2 (L1/L2) signaling, and the gNB 200 may also dynamically configure the MBS gap. For example, the UE 100 may indicate the gNB 200 that an MBS gap is required in the time slots after the current time slot. The indication includes information indicating a time slot in which the gap is required (for example, the number of slots after which the gap is required). At a point in time when the gNB 200 has received the request, the gNB 200 may recognize that the gap is applied in the time slot (the UE 100 does not perform reception processing), or the gNB 200 may explicitly configure application of the MBS gap in the time slot to the UE 100. The L1/L2 signaling is DCI and/or MAC CE. The L1/L2 signaling may include at least some of information elements included in the RRC message. The L1/L2 signaling may be transmitted from the UE 100 when transmission of the UE 100 is permitted from the gNB 200 (for example, when a configuration is made by RRC Reconfiguration).

Similarly, the UE 100 may dynamically request SCell release (or SCell deactivation) using layer 1 or layer 2 (L1/L2) signaling, and the gNB 200 may dynamically configure SCell release (or SCell deactivation) as well.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although an example in which the base station is an NR base station (that is, gNB) has been described in the embodiments and the examples described above; the base station may be an LTE base station (that is, an eNB) or a 6G base station. Further, the base station may be a relay node such as an Integrated Access and Backhaul (IAB) node. The base station may be a DU of the IAB node. Further, the UE 100 may be a Mobile Termination (MT) of the IAB node.

Also, the term “network node” mainly refers to a base station, but may also refer to a device of a core network or a part (CU, DU or RU) of the base station.

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to,” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design changes and the like can be made without departing from the gist of the present disclosure.

### (6) Supplements

Characteristics regarding the embodiments described above are described below as supplements.

### Supplement 1

A communication method used in a mobile communication system providing a multicast/broadcast service (MBS), the communication method including the steps of communicating, by a user equipment to which a plurality of serving cells are configured, with a network by using the plurality of serving cells; and transmitting, by the user equipment to the network, request information where the user equipment requests release or deactivation of any of the plurality of serving cells, in order to perform MBS reception of a different cell different from the plurality of serving cells.

### Supplement 2

The communication method according to supplement 1, wherein the request information is information requesting release or deactivation of a secondary cell among the plurality of serving cells.

### Supplement 3

The communication method according to supplement 1 or 2, wherein the request information includes at least one of an identifier of a serving cell that is a target of the release or the deactivation or an identifier of a frequency that is a target of the release or the deactivation.

### Supplement 4

The communication method according to any one of Supplements 1 to 3, further including a step of transmitting, by the user equipment and when the user equipment terminates the MBS reception of the different cell, indication information on the termination to the network.

### Supplement 5

A communication method used in a mobile communication system providing a multicast/broadcast service (MBS), the communication method including the steps of communicating, by a user equipment to which one or more serving cells are configured, with a network by using the one or more serving cells; and having, by the user equipment, interest in MBS reception in a different cell different from the one or more serving cells; and determining, by the user equipment, whether a transmission condition where the user equipment transmits request information to the network is satisfied, the request information where the user equipment performing MBS reception in the different cell, wherein the request information is information requesting configuration of an MBS gap or information requesting release or deactivation of a serving cell, and the determining includes determining whether a condition that the network does not provide a system information block including information of a frequency targeted for the MBS reception is satisfied.

### Supplement 6

The communication method according to any one of supplements 1 to 5, wherein the different cell is a cell belonging to a different network of an operator different from an operator of the network.

### (7) Supplement

Supplements regarding the above-described embodiment will be added.

### Introduction

Work items regarding MBS enhancement (eMBS) include the purpose of supporting UE shared processing for MBS broadcast and unicast, as follows.
An extension of Uu signaling for allowing the UE to use shared processing for MBS broadcast and unicast reception is defined. That is, reporting of UE capability and related assistance information regarding simultaneous reception of unicast reception in RRC connected and MBS broadcast reception from the same or different operator is included.

In the RAN2 #119e, the following agreement was obtained.
The RAN2 will focus on a solution targeted for multi-RxUE (that is no special function enhancement for one RxUE).

### Discussion

### GAP Configuration

In a justification part of a WID, it is specified that the UE receives an MBS service of interest from a different operator, that is, performs inter-PLMN MBS reception.

In a Rel-17NRMBS broadcast solution, the UE can receive the broadcast service only on the downlink. However, in a general use case of the broadcast, the UE may need to simultaneously receive a broadcast service, and a unicast service from a network of the same operator or the different operator, and some UEs may share hardware resources between broadcast and unicast. Therefore, in such a UE, the unicast connection is likely to be influenced by the broadcast reception. It is necessary to focus on a case of unicast reception in RRC connected and broadcast reception from the same or different operator (including emergency broadcast and public safety broadcast).

In the case of shared processing, the UE can use the same reception device for MBS broadcast and unicast. As described above, since the MBS service is likely to be provided by the different operator, the MBS service is provided at different frequencies. When one reception device is used for the different frequencies, the UE needs to tune the RF chain to frequencies thereof in a TDD manner. Therefore, an additional gap for MBS broadcast reception is required for shared processing. Since the gNB avoids scheduling of DL transmission for unicast during this gap, the UE can receive an intended MBS broadcast on the different frequency/operator. This is similar to a measurement gap for inter-frequency measurement or a MUSIM gap for an inter-PLMN operation.

Observation 1: The UE can tune the RF chain to a frequency different from the MBS frequency during a gap where the gNB does not schedule unicast transmission and reception.

An issue with the gap is whether an existing MUSIM gap can be reused for MBS reception. Technically, the MUSIM gap is likely to be extended for MBS reception, for example, by adding periodicity or length. However, in a current specification, the MUSIM gap is limited to purpose of the MUSIM as follows. It is clear that a current MUSIM gap is not intended to be used for MBS reception.

When the UE needs a gap pattern for MUSIM purpose such as cell identification and measurement, paging monitoring, SIB acquisition, and/or on-demand SI request of a target cell of a target network, the network may provide one or more per-UE MUSIM gap patterns for simultaneous monitoring of all frequency layers for MUSIM via MUSIM-GapConfig.

Further, when the same gap is used for different purposes, unnecessary complexity is expected. In fact, the MUSIM gap is introduced separately from an existing measurement gap in Rel-17 and is simpler from the point of view of both the network and the UE or from the point of view of the specification and implementation. Therefore, it is considered desirable to introduce an additional gap specific to inter-frequency/inter-PLMN MBS reception, which is different from the MUSIM gap.

Proposal 1: The RAN2 should agree to introduce additional gaps for inter-frequency (and inter-PLMN) reception of MBS broadcast in RRC connected, that is “MBS gap”.

### Gap Assistance Information

When proposal 1 can be agreed, the gNB needs to configure the MBS gap for the UE, but the gNB does not know what gap pattern the UE needs. Therefore, the UE needs to transmit assistance information to indicate details of the required gap to the gNB. This is because details of the MBS broadcast configuration of different operators, such as the MTCH scheduling information, are not ascertained in the current network (that is, the selected PLMN). This is similar to MUSIM assistance introduced in UAI.

Proposal 2: The RAN2 should agree to introduce additional assistance information from the UE into the MBS gap configuration, especially when the MBS broadcast of interest is provided from the different PLMN.

When proposal 2 can be agreed, it is worth considering what assistance information is needed. Currently, the UE can indicate the MBSInterestIndication (MII) to the gNB. The MII includes TMGI, frequency, and a priority of MBS broadcast and unicast. When the same operator provides an MBS broadcast of interest, the current MII sufficiently works because the gNB is likely to ascertain, for example, the MTCH scheduling information of a specific TMGI provided on a different frequency.

It is to be noted that it is necessary for the gNB to provide the SIB21 so that the UE can transmit the MII regardless of whether the gNB provides the MBS service.

Proposal 3: In the case of intra-PLMN, the RAN2 should agree to take an existing MBS interest indication as the assistance information of the MBS gap.

Since the gNB of the selected network does not ascertain the MBS broadcast configuration of the different network, the UE needs to provide the gap pattern to the gNB when the different operator provides the intended MBS broadcast. The gap pattern needs to be based on the MTCH scheduling information of the different operator, while the reference needs to be based on the selected network. Further, the RF tuning time may also be included, and how to configure the gap pattern is left to the UE implementation.

Proposal 4: In the case of inter-PLMN, the RAN2 should agree that the UE requests a gap pattern from the gNB, and the gap pattern may cover an RF coordination time and an MTCH scheduling period of different PLMNs.

In RAN2 #119e, additional information of MII similar to a ROM of LTEeMBMS, such as a ROM frequency, a ROM subcarrier spacing, and bandwidth has been proposed. However, since the subcarrier spacing and the bandwidth of MBS transfer of the different operator do not carry time domain information such as MTCH occasion, it is unclear how the subcarrier spacing and the bandwidth can support gNB of NR. Also, in NRMBS, since the frequency of the MII can be determined based on the USD even when such frequencies are not described in SIB21, existing frequency information of the MII can be used in the same way as the ROM frequency of the LTEeMBMS.

Observation 2: The extension of the MBS interest indication for ROM support of LTEeMBMS is not directly applicable to NRMBS shared processing.

### Other Considerations

In RAN2 #119e, some companies comment that a gap mechanism is complex from the network point of view. In this case, whether to permit the MBS gap and corresponding assistance information depends on the implementation of the network. However, when all the reception devices of the UE are used for unicast transfer of a serving network, a fundamental problem remains as to whether the UE can receive the MBS service from the different network (for example, when the UE cannot receive the intended MBS service due to carrier aggregation configuration).

As one simple method for allowing the UE to use one of the reception devices thereof for MBS reception, the gNB de-configuring or deactivating one of SCells that are currently active in the UE is considered although this is not “shared processing”. However, since the gNB is likely not to ascertain whether/when the UE prefers SCell de-configuration/deactivation, it is worth discussing whether the additional assistance information of SCell de-configuration/deactivation for MBS reception is useful in addition to the MBS gap. When the additional assistance information is recognized as useful, whether the content of the current MII, that is, the frequency and priority, works for a purpose thereof should be discussed.

Proposal 5: The RAN2 should further discuss whether the UE is permitted to indicate a priority for reconfiguration or deactivation of SCell to the gNB, for MBS reception from a different PLMN.

### REFERENCE SIGNS

1: Mobile communication system
10: RAN
20: CN
100: UE (User equipment)
110: Receiver
120: Transmitter
130: Controller
200: gNB (base station)
210: Transmitter
220: Receiver
230: Controller
240: Backhaul communicator

1. A communication method used in a mobile communication system providing a multicast/broadcast service (MBS), the communication method comprising:
communicating, by a user equipment to which a plurality of serving cells are configured, with a network by using the plurality of serving cells;
receiving, by the user equipment from a non-servicing cell of the user equipment, information related to MBS frequency in the non-servicing cell, the non-serving cell being different from the plurality of serving cells of the user equipment;
transmitting, by the user equipment to the network, a first MBS Interest Indication (MII) including the information related to the MBS frequency in the non-serving cell, in order to perform MBS reception from the non-serving cell; and
transmitting, by the user equipment to the network, a second MII, upon terminating the MBS reception from the non-serving cell.

2. A user equipment in a mobile communication system providing a multicast/broadcast service (MBS), the user equipment comprising:
a wireless communicator, configured to perform wireless communication with a network by using a plurality of serving cells that are configured to the user equipment, the wireless communicator comprising:
a receiver circuitry, receiving, from a non-serving cell of the user equipment, information related to MBS frequency in the non-serving cell, the non-serving cell being different from the plurality of serving cells of the user equipment;
a transmitter circuitry, transmitting, to the network, a first MBS Interest Indication (MII) including the information related to the MBS frequency in the non-serving cell, in order to perform MBS reception from the non-serving cell, and transmitting, to the network, a second MII, upon terminating the MBS reception from the non-serving cell.

3. A chipset for a user equipment used in a mobile communication system for providing a multicast/broadcast service (MBS), the chipset comprising:
a circuity configured to:
communicate, with a network by using a plurality of serving cells which are configured to the user equipment;
receive, from a non-serving cell of the user equipment, information related to MBS frequency in the non-serving cell, the non-serving cell being different from the plurality of serving cells of the user equipment;
transmit, to the network, a first MBS Interest Indication (MII) including the information related to the MBS frequency in the non-serving cell, in order to perform MBS reception from the non-serving cell; and
transmit, to the network, a second MII, upon terminating the MBS reception from the non-serving cell.
